(19) United States
(12) Patent Application Publication
(10) Pub. No.: US 2008/0100470 A1
(43) Pub. Date: May 1, 2008

(54) SIDE TURN INDICATOR

(75) Inventor: Scott M. Conway, Flower Mound, TX (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: PACCAR INC, Bellevue, WA (US)

(21) Appl. No.: 11/555,572

(22) Filed: Nov. 1, 2006

(51) Int. Cl. G09F 9/33; B60Q 1/34

(52) U.S. Cl. 340/815.45; 340/475

(57) ABSTRACT

An LED-illuminated marker or indicator light for motor vehicles is provided. The light is designed so that when the light is mounted on the motor vehicle the light from some LEDs is directed toward a zone in which an intended viewer is likely located. Other LEDs illuminate light guides to increase the visual area of the marker or indicator light.

The present invention relates in general to a lamp for a motor vehicle and more particularly to an external marker or indicator lamp such as a side turn signal indicator lamp.

### BACKGROUND OF THE INVENTION

Motor vehicles typically have several marker and indicator lamps. These lamps enhance vehicle safety by providing information to other drivers. For example, running lamps make a vehicle more visible at night; brake lamps indicate that a vehicle may be slowing down or stopping; and turn signals indicate that a vehicle is about to turn or move in a new direction.

Marker and indicator lamps can only provide information to other drivers if the other driver sees the lamps. First, the marker or indicator lamps must be in the driver's field of view. Second the marker or indicator lamps must be noticed by the driver. For example, when a driver is alongside another vehicle the turn signal lamps on the front and rear of the other vehicle may not be visible to the driver. Even if one of the turn signal lamps is in the driver's field of view, it may not be noticed, because the light from the lamp is directed away from the driver or the indicator lamp is not be large enough to attract the driver's attention.

As a result, the driver may not be alerted when the other vehicle is about to change lanes or make a turn. This is particularly problematic for large vehicles such as tractor trailers or buses because the driver of a car alongside the large vehicle might not see a turn signal on the large vehicle, and the driver of the large vehicle may not see the car alongside.

### SUMMARY OF THE INVENTION

The objects and advantages of the present invention are provided by a marker or indicator lamp in which light is generated by a plurality of light emitting diodes (LEDs). Some of the LEDs are oriented to optimize the visibility of the LEDS when the lamp is mounted on a vehicle. Other LEDs are oriented to direct light into one or more light guides configured to illuminate a large area.

### BRIEF DESCRIPTION OF THE DRAWINGS

These and other objects and advantages of the present invention will be understood upon consideration of the detailed description taken in conjunction with the accompanying drawings, in which like reference characters refer to like parts, and in which:

FIG. 1 is a top view of a motor vehicle having a side turn signal;

FIG. 2 is a perspective view showing a truck having an illustrative embodiment of a side turn signal in accordance with the principles of the present invention;

FIG. 3 is a perspective view of the illustrative side turn signal of FIG. 2; and

FIG. 4 is an exploded view of the illustrative side turn signal of FIG. 3.

### DETAILED DESCRIPTION

The principles of the present invention relate to the design and use of marker and indicator lights for motor vehicles such as boats, cars, trucks, aircraft, and the like. These principles are described herein with reference to an illustrative side turn signal. A side turn signal is defined by the Society of Automotive Engineers (SAE) in specification SAE J914 as a lighting device normally mounted on the side of a vehicle at or near the front, and used as part of the turn signal system to indicate a change in direction by means of a flashing warning signal on the side toward which the vehicle operator intends to turn or maneuver. One skilled in the art will understand that other marker and/or indicator lights may be designed and used in accordance with the principles of the present invention.

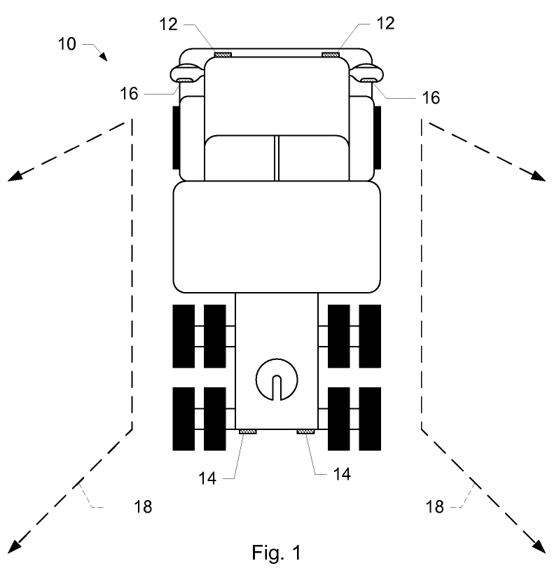

FIG. 1 shows an overhead view of motor vehicle 10 having forward turn signal 12 and rear turn signal 14. Light from forward turn signal 12 is primarily directed forward of motor vehicle 10 to warn drivers in front of motor vehicle 10, such as drivers in opposing or crossing traffic. Light from rear turn signal 14 is primarily directed behind motor vehicle 10 to warn drivers behind motor vehicle 1O. However, a driver in a vehicle along side of motor vehicle 10 may not notice turn signals 12 and 14. Accordingly, motor vehicle 10 provides side turn signal 16 to warn drivers to the side of motor vehicle 10.

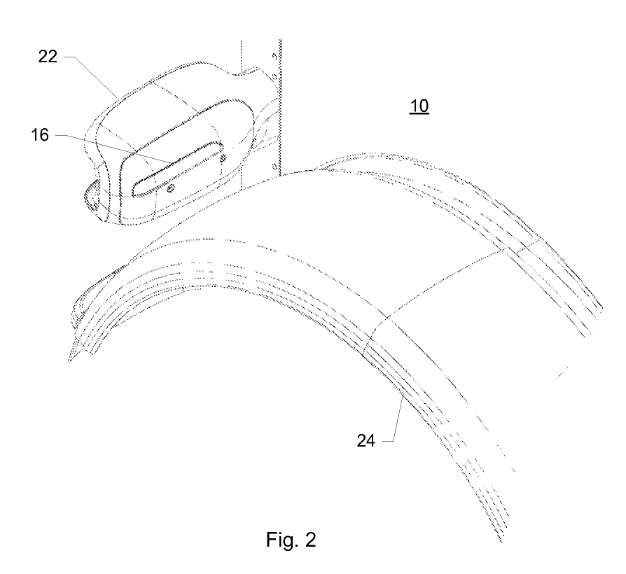

Generally, side turn signal 16 is designed to warn drivers in the zone indicated by dashed lines 18 in FIG. 1. An illustrative configuration for providing a side turn signal is shown in FIG. 2, wherein side turn signal assembly 20 is mounted on the back of headlight pod 22. Alternatively, side turn assembly 20 may be mounted in fender 24, or in another suitable location.

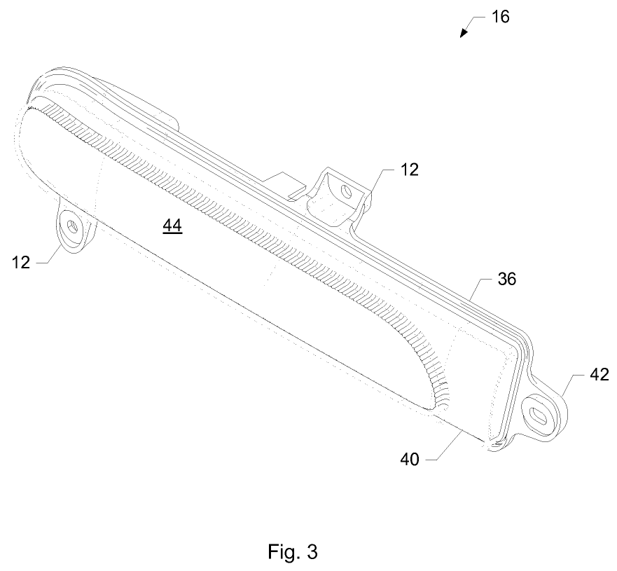

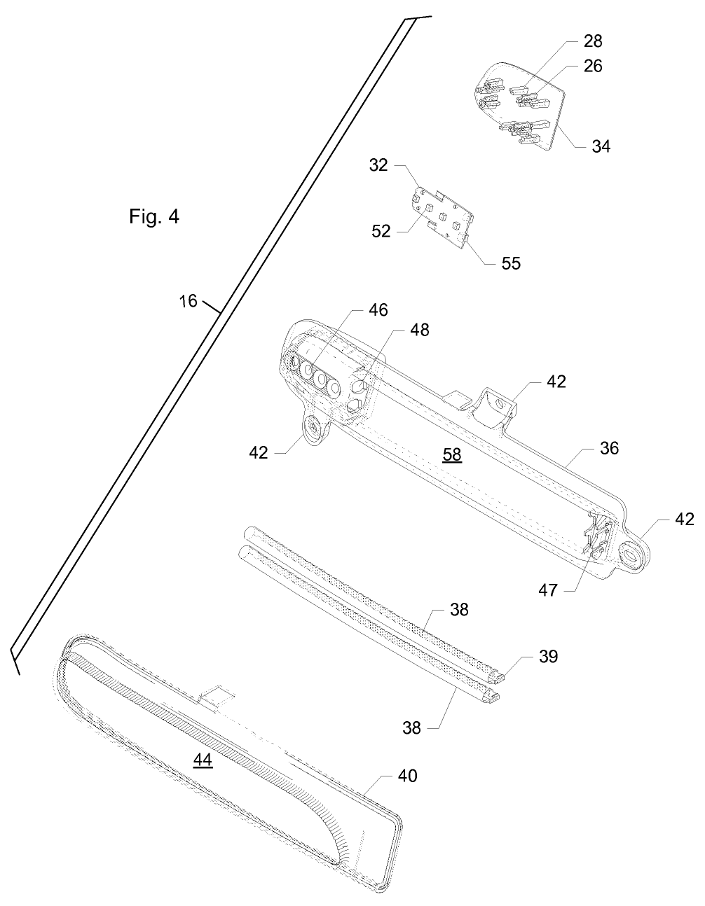

The construction of illustrative side turn signal 16 is shown in more detail in FIGS. 3 and 4 which are respectively, an assembly view and an exploded view of side turn signal 16. As shown, side turn signal 16 is an assembly comprising several components, including circuit board 32, rear cover 34, housing 36, light guides 38, and lens 40. The components are preferably designed to be assembled without tools, such as by providing interlocking clips, tabs, teeth, latches, or other features whereby the components snap together. Alternatively, the components may be assembled by means of adhesives, bolts, rivets, screws, welding, or other suitable means.

Housing 36 includes mounting tabs 42 for attaching side turn signal 16 to motor vehicle 10. As shown in FIG. 2, illustrative side turn signal 16 is designed to fit in head lamp pod 22. Accordingly, mounting tabs 42 are designed for attaching side turn indicator 16 to head lamp pod 22. Lens 40 includes raised portion 44 that has a shape corresponding to a slot or opening in the back of head lamp pod 22 and has a surface that matches the surface shape of head lamp pod 22.

Typical marker and indicator lamps use incandescent bulbs which are relatively fragile, and prone to burn out or break. In contrast, Light Emitting Diodes (LEDs) are more robust, turn on faster, and use less current than incandescent bulbs. As a result, LEDs are overtaking incandescent bulbs in some applications. Due to recent advances in LED technologies, a single high intensity LED is capable of fulfilling the requirements of SAE J914. In accordance with the principles of the present invention, side turn signal 16 is illuminated by high intensity LEDs. As shown in FIG. 4, LEDs 52 and 55 are mounted circuit board 32, which acts as a substrate for the LEDs. Circuit board 32 may also include other electrical components and circuit elements. For example, circuit board 32 may include one or more resistors to limit the maximum current that can flow through the LEDs. A controller may be used to operate the LEDs in a sequence and/or to pulse the LEDs at a high current. An electrical connection is provided for connecting to the vehicle wiring harness.

Circuit board 32 is positioned in rear housing 36 so that LEDs 52 are located adjacent to and point out of openings 46, and LEDs 55 are located adjacent to and point out of openings 48. Rear cover 34 includes posts or stand-offs 26 designed to position circuit board 32 within housing 36. Preferably, rear cover 34 includes clips 28 to securely hold circuit board 32 on posts 26 and clips 30 designed to mate with corresponding portions of rear housing 36. Clips 28 and 30 enable the components to be assembled without tools.

LEDs are not without drawbacks. An incandescent bulb provides omnidirectional illumination, whereas the illumination provided by an LED is more directional. The illumination provided by an LED is primarily directed in an elliptical cone oriented along the optical axis of the LED. Therefore, an LED appears much brighter when viewed from a position near the optical axis than when viewed from an off-axis position.

In accordance with the principles of the present invention, rear cover 34, circuit board 32, and housing 36 are designed so that when side turn signal 16 is mounted on a motor vehicle LEDs 52 are oriented so that their illumination is directed toward the area in which some one viewing the side turn signal is likely to be. Preferably, this is done by orienting the optical axis of the LED toward the target area. Alternatively, a portion of the cone of illumination provided by the LEDs is directed toward the target area. For example, in FIG. 1 it would be preferable for LEDs 52 in side turn signal 16 to be oriented so that they are aimed at zone 18. However, because of the illumination cone, it is acceptable if LEDs 52 are oriented so that their optical axis is generally parallel to the longitudinal axis of motor vehicle 10.

To further increase the visibility, side turn signal 16 is designed to have an larger illuminated or projected area than the area of LEDs 52 alone. This is provided by light guides or light pipes 38 in combination with LEDs 55 and housing 36. Light guides are optical structures made of substantially transparent materials in which light coupled into the structure is guided throughout the body of the structure via internal reflection. Out coupling elements reflect some of the out of the light guide. Preferably, light guides 38 are plastic bars or rods disposed in housing 36 so that they are illuminated by LEDs 55. For instance, one end of light guides 38 includes tabs 39 that fit into corresponding slots 47 in housing 36. The other end of light guides 38 is shaped to fit opening 48. As described above, rear cover 34 holds circuit board 32 so that LEDs 55 are adjacent to and directed toward openings 48. Thus, light guides 38 are illuminated by LEDs 55.

The light from LEDs 55 is guided throughout light guides 38 by internal reflection and/or refraction. A rear surface of light guides 38 is faceted, corrugated, or otherwise textured to form out coupling elements to direct the internally reflected light light from LEDs 55 outward through lens 40. A portion of light guides 38 may be metalized. To further enhance the visibility of side turn signal 16, housing 36 includes reflector 58 behind light guides 38. Reflector 58 directs light exiting from the sides of light guides 38 outward though lens 40. Preferably, reflector 58 is a suitably shaped and metalized portion of housing 36, although it may be a separate component.

Thus, an improved marker or indicator lamp and methods of making and using same have been provided. One skilled in the art will appreciate that the present invention can be practiced by other than the described embodiments, which are presented for purposes of illustration and not of limitation, and that the present invention is limited only by the claims which follow.

What is claimed is:

1. A lamp for a motor vehicle, the lamp comprising:
a housing including a reflector and a lens;
a first LED disposed within said housing such that an optical axis of the first LED is oriented approximately orthogonal to a surface of the lens;
a light guide disposed within the housing; and
a second LED disposed within the housing such that light from the second LED is directed into the light guide.

2. A lamp as recited in claim 1, wherein the light guide is a rod.

3. A lamp as recited in claim 2, wherein a rear portion of the rod is faceted or corrugated.

4. A lamp as recited in claim 2, wherein a reflective coating is disposed on a rear portion of the rod.

5. A lamp as recited in claim 1 further comprising a substrate, wherein the first and second LEDs are mounted on the substrate.

6. A lamp as recited in claim 5, wherein the first and second LEDs are mounted on opposite surfaces of the substrate.

7. A lamp as recited in claim 1, wherein the lamp comprises a side turn signal indicator designed such that when the side turn indicator is mounted on a motor vehicle the optical axis of the first LED is approximately parallel to a center line of the motor vehicle.

8. A lamp as recited in claim 7, wherein the side turn indicator is designed such that when the side turn indicator is installed on a motor vehicle the light guide is approximately perpendicular to a center line of the motor vehicle and parallel with the ground.

9. An indicator lamp for a motor vehicle, the lamp comprising:
a housing configured to be disposed from the motor vehicle, the housing including a lens;
a first LED disposed within said housing such that an optical axis of the LED is oriented toward an expected position of a viewer of the indicator lamp when the indicator lamp is disposed from the motor vehicle;
a second LED disposed within the housing such that an optical axis of the second LED is oriented at a broad angle with respect to the optical axis of the first LED; and
a light guide disposed within the housing so as to receive light from the second LED.

10. An indicator lamp as defined in claim 8, wherein the indicator lamp is a side turn indicator and the expected position of a viewer is generally beside the motor vehicle.

11. An indicator lamp as defined in claim 9, wherein the expected position of the viewer comprises an area beside the motor vehicle in which turn signal indicators on the front and rear of the motor vehicle are not visible.

12. An indicator lamp as defined in claim 8, wherein the optical axis of the first LED is approximately perpendicular to an optical axis of the second LED.

13. An indicator lamp as defined in claim 8, wherein the optical axis of the first LED is approximately parallel to a centerline of the motor vehicle.

14. An indicator lamp as defined in claim 8, wherein the light guide comprises a rod having a faceted rear surface.

15. A method for providing a signal light for a motor vehicle, the signal light being designed to be viewable from a predetermined zone near the motor vehicle, the method comprising:
providing a housing configured to be disposed from the motor vehicle, the housing including a lens;
providing a first LED disposed within said housing such that an optical axis of the LED is oriented toward the predetermined zone when the indicator lamp is disposed from the motor vehicle;
providing a light guide disposed within the housing so that it is oriented generally perpendicular to the optical axis of the first LED; and
providing a second LED disposed within the housing so as provide illumination to the light guide.

16. A method as defined in claim 14, wherein providing the light guide comprises providing a rod-shaped light guide having a plurality of facets on a rear portion thereof.

17. A method as defined in claim 15, further comprising providing a reflective coating on the facets.

18. A method as defined in claim 14, further comprising a reflector near the light guide to reflect light toward the predetermined zone.

19. A method as defined in claim 17, wherein the predetermined zone comprises an area beside the motor vehicle in which side turn signal indicators on the front and rear of the motor vehicle are generally not visible.

20. A method as defined in claim 15, wherein providing first and second LEDs comprises providing a first plurality of LEDs and a second plurality of LEDs.

21. A method as defined in claim 19, wherein optical axes of the first plurality of LEDs are oriented generally parallel to a center line of the motor vehicle and optical; axes of the second plurality of LEDs are oriented generally perpendicular to the center line of the motor vehicle and generally parallel to the ground.
